(19) United States
(12) Patent Application Publication
(10) Pub. No.: US 2006/0205394 A1
(43) Pub. Date: Sep. 14, 2006

(54) Mobile device, a network element and a method of adjusting a setting associated with a mobile device

(76) Inventor: Matti I. Vesterinen, Helsinki (FI)

Correspondence Address: PERMAN & GREEN, 425 POST ROAD, FAIRFIELD, CT, 06824, US

(21) Appl. No.: 11/077,563

(22) Filed: Mar. 10, 2005

(51) Int. Cl. H04M 1/66

(52) U.S. Cl. 455/418; 455/411

(57) ABSTRACT

User activity settings and other settings such as sound and vibration settings of applications that run on mobile devices are automatically adjusted. In one example, the mobile device includes a processor configured to adjust a user activity setting automatically according to an activity being carried out by a user. The activity of the user is determined by detected changes such as changes in the location or movement of the mobile device. The user activity setting can be associated with an application such as an instant messaging (IM) application stored in the memory of the mobile device.

### FIELD OF THE INVENTION

The invention relates to the field of mobile telecommunications and particularly, but not exclusively, to a method of automatically adjusting a user activity setting associated with a mobile device.

### BACKGROUND OF THE INVENTION

Applications capable of receiving and storing user status information are becoming available on mobile devices. One such application is instant messaging (IM), which enables a mobile user to communicate with other mobile users via a series of messages displayed on the screen of their mobile device in the form of a conversation. Instant messaging applications conventionally enable a user to select from a plurality of user status settings to indicate their availability. The particular chosen setting is made available, via the mobile network, to selected mobile users stored as contacts in the electronic address book of the mobile device. In this way, the setting can be used to provide information regarding the current status and contactability of a user to other mobile users.

When a user requires their status to be altered, the user is conventionally required to select the new status they require manually using the mobile device keypad. This can involve the user navigating one or more on-screen menus from which the required setting can be selected. Since this takes time, users often choose not to, forget, or are unable to update their status every time their situation changes. This can lead to the user's status being inaccurate and, as a result, the user having the wrong device settings, as well as other mobile users being provided with incorrect information.

### SUMMARY OF THE INVENTION

According to a first aspect of the invention, there is provided a mobile device comprising a processor configured to automatically adjust at least one user activity setting associated with the mobile device in response to information indicative of the movement of the mobile device.

Therefore, the user activity setting, which can provide an indication of user status beyond simple availability, can be automatically set according to a user's movement. This enables the user activity setting to immediately and accurately reflect the user's current activity. For instance, when a user is driving, they may wish to have their user activity setting automatically updated to reflect this. However, the user may forget to update their activity setting and, once driving, may not be able to do so. The present invention obviates the need for a user to manually set their activity setting every time their activity changes and therefore overcomes this problem.

The user activity setting can be associated with an application operable to run on the mobile device. The application can comprise an instant messaging application.

The processor can be configured to adjust a setting associated with an application operable to run on the mobile device in accordance with the user activity setting. In this case, the user activity setting may be a general or global setting stored by the mobile device, also referred to as a device setting, which is used to update one or more settings associated with applications running on the device.

The setting associated with the application may be at least one of a sound and a vibration setting. Accordingly, the behaviour of the device when running applications can be adjusted in accordance with the user activity setting.

The processor can be configured to adjust a plurality of respective settings, each associated with a respective one of a plurality of applications operable to run on the mobile device, said adjustment being carried out in accordance with the user activity setting.

The mobile device may comprise a transceiver configured to transmit the user activity setting over a network. The user activity setting can thus be made available to other devices, including, for example, a network element or server that holds activity settings for a plurality of mobile devices.

The processor can be configured to automatically adjust the user activity setting in response to detection of at least one hand-over of the mobile device between elements of at least one network. The elements may, for instance, be base transceiver stations in a mobile network. Alternatively, the elements may be servers or other communication devices associated with one or more networks.

In particular, the processor can be configured to automatically adjust the user activity setting according to the frequency of detected hand-overs. The detected hand-overs may comprise a first hand-over between a first network element and a second network element and a second hand-over between the second network element and a third network element.

The one or more networks may comprise at least one of a cellular network, a local area network (LAN), a personal area network (PAN), a wide area network (WAN), or a wireless LAN, WAN or PAN.

The processor can be configured to automatically adjust the user activity setting in response to a change in the signal strength of signals received at the mobile device.

The mobile device may comprise a movement sensor configured to detect movement of the mobile device. The information indicative of the movement of the mobile device can, in this case, be based on the output of the movement sensor.

The mobile device may comprise a memory configured to store a preference relating to the allowability of automatic user activity setting adjustments. Accordingly, a user can adjust the preference to selectively enable or disable automatic updates of their user activity setting in response to one or more activities that they commence.

The mobile device may comprise an air sensor for detecting environmental characteristics in the vicinity of the device. The information indicative of the movement of the mobile device can, in this case, be based on the output of the air sensor.

The processor can be configured to adjust a user profile of the mobile device according to the user activity setting. The user profile may, for instance, be a user-editable setting associated with a mobile terminal that controls the sound and vibration alerts associated with functions of the terminal such as receiving telephone calls and text messages.

According to a second aspect of the invention, there is provided a mobile device comprising a processor configured to automatically adjust at least one user activity setting associated with the mobile device in response to information indicative of the location of the mobile device.

The user activity setting may be associated with an application operable to run on the mobile device.

The processor can be configured to adjust a setting associated with an application operable to run on the mobile device in accordance with the user activity setting.

The setting can be at least one selected from the group comprising a sound setting and a vibration setting.

The processor can be configured to adjust a plurality of respective settings, each associated with a respective one of a plurality of applications operable to run on the mobile device, said adjustment being carried out in accordance with the user activity setting.

The mobile device may comprise a detector configured to detect that the mobile device is located within a vehicle or any other form of transport. For instance, connection via a Bluetooth™ port of the mobile device to an in-car computer could be detected by the detector and the user activity setting adjusted accordingly.

The mobile device may comprise a detector configured to detect an in-car accessory connected to the mobile device. The connection could be by wired or wireless means. The information indicative of the location of the mobile device can therefore be based on the output of the detector. For instance, when the user enters a car and connects an accessory such as an in-car charger or ‘hands-free’ audio device to the mobile device, this is detected by the detector and the user activity setting can be adjusted according to the detector output.

The mobile device may comprise a detector configured to detect a radio frequency tag and to provide a signal to the processor indicative of the detected radio frequency tag. As a result, in response to the detection of a radio frequency identification (RFID) tag, the processor can identify the RFID tag that has been detected and set the user activity setting to a value based on the identification.

The processor can be configured to automatically adjust the user activity setting in response to communications received at the mobile device from an element of at least one network. The network can comprise at least one of a cellular network, a local area network (LAN), a personal area network (PAN), a wide area network (WAN), or a wireless LAN, WAN or PAN. In particular, the network may comprise a cellular network and the network element may comprise a base transceiver station. The mobile device in this case can determine the mobile network cell in which it is located according to registration signals received from a base transceiver station (BTS) in the cellular network.

According to a third aspect of the invention, there is provided a network element configured to automatically adjust a user activity setting associated with a mobile device in response to information indicative of the movement of the mobile device.

The user activity setting is thus adjusted by the network element rather than the mobile device. This can have advantages as regards minimising the power consumption of the mobile device and reducing the number of transmissions from the mobile device over a network to which the mobile device may be connected.

The network element can be configured to automatically adjust the user activity setting in response to a signal received from the mobile device. This can, for instance, be a signal indicative of the movement of the mobile device.

The network element can be configured to automatically adjust the user activity setting in response to detection of at least one hand-over of the mobile device between components of at least one network. In particular, the network element can be configured to automatically adjust the user activity setting according to the frequency of detected hand-overs.

The network may comprise one of a cellular network, a local area network (LAN), a personal area network (PAN), a wide area network (WAN), a wireless LAN, WAN or PAN.

The network element can comprise a server arranged to receive the information indicative of the movement of the mobile device from the mobile device, and in response to the information to change the user activity setting held at the server for the mobile device, the server being arranged to make the user activity setting available to a plurality of other devices.

The movement of the mobile device can be sensed by apparatus external to the mobile device, the network element comprising a server arranged to receive information indicative of the movement of the mobile device from said apparatus, and in response to the information to change the user activity setting held at the server for the mobile device.

The mobile device itself does not therefore need to be involved in the status detection process and the process of maintaining the device status and distributing it to other servers and devices can be performed at a network side.

The server can be arranged to send the user activity setting to the mobile device and to make the user activity setting available to a plurality of other devices.

According to a fourth aspect of the invention, there is provided a network element configured to automatically adjust a user activity setting associated with a mobile device in response to information indicative of the location of the mobile device.

The network element may be associated with a network comprising at least one of a cellular network, a local area network (LAN), a personal area network (PAN), a wide area network (WAN), a wireless LAN, WAN or PAN.

The network element can be configured to automatically adjust the user activity setting in response to a signal received from the mobile device. For example, a signal received by a particular base transceiver station (BTS) from the mobile device indicates that the mobile device is located within the cell of a cellular network associated with that BTS.

According to a fifth aspect of the invention, there is provided a mobile device comprising a processor configured to automatically adjust a user activity setting associated with the mobile device in response to an activity performed by a user of the mobile device that is other than communicating using the mobile device.

The activity may comprise use, by a user, of an application running on the mobile device.

The application can comprise at least one selected from the group comprising a game, a web browser, a television application, a radio application, a streaming application and an enterprise application, such as enterprise resource planning and customer relationship management applications.

The processor can be configured to automatically adjust the user activity setting in response to a secure internet connection associated with the mobile device. Secure internet connections generally involve the transfer of data that is of higher importance than conventional internet connections. Adjusting the user activity setting in response to a secure internet connection can therefore have the advantage of making applications running on the mobile device or users of other mobile devices aware that a secure internet connection is established. This can therefore reduce the risk that the secure internet connection is disrupted.

The processor can be configured to automatically adjust the user activity setting in response to the output of a heart monitor associated with the mobile device.

The processor can be configured to automatically adjust the user activity setting in response to the output of a microphone associated with the mobile device.

The processor may be configured to adjust a user profile of the mobile device according to the user activity setting.

According to a sixth aspect of the invention, there is provided a method of automatically adjusting a user activity setting associated with a mobile device, the method comprising adjusting the user activity setting in response to information indicative of the movement of the mobile device.

The method can comprise receiving the information at a server, adjusting the user activity setting at the server and transmitting the user activity setting from the server to the mobile device.

According to a seventh aspect of the invention, there is provided a method of automatically adjusting a user activity setting associated with a mobile device, the method comprising adjusting the user activity setting in response to information indicative of the location of the mobile device.

### BRIEF DESCRIPTION OF THE DRAWINGS

To aid understanding of the invention, embodiments thereof will now be described, purely by way of example, with reference to the accompanying drawings, in which:

FIG. 1 illustrates a mobile terminal according to the invention;

FIG. 2 is a flow diagram illustrating a process according to the invention of adjusting a global user activity setting in response to a user of a mobile device using an application running on the device;

FIG. 3 illustrates a mobile telecommunications network;

FIG. 4 is a flow diagram illustrating one process according to the invention of adjusting a global user activity setting in response to a user of a mobile device changing location;

FIG. 5 is a flow diagram illustrating a second process according to the invention of adjusting a global user activity setting in response a mobile device detecting a radio frequency identification tag; and

FIG. 6 is a flow diagram illustrating a further process according to the invention of adjusting a user profile associated with a mobile terminal according to a global user activity setting adjustment.

### DETAILED DESCRIPTION OF THE INVENTION

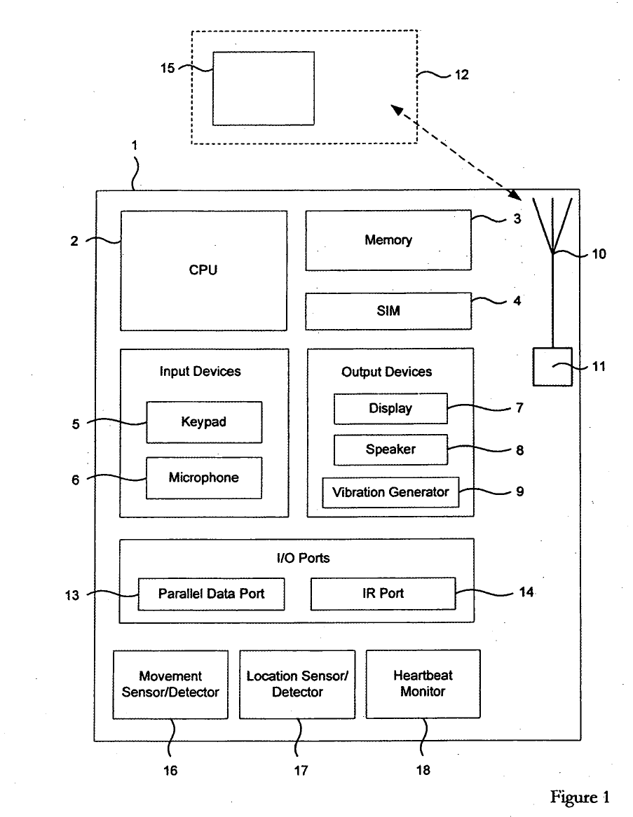

Referring to FIG. 1, a mobile telecommunications terminal 1 includes a central processing unit (CPU) 2, a memory 3 and a subscriber identification module (SIM) 4. The mobile terminal 1 also includes input devices, in this case a keypad 5 and a microphone 6 as well as output devices, in this case a display 7, speaker 8 and vibration generator 9. An antenna 10 connected to a transceiver 11 enables the mobile terminal 1 to communicate over a wireless mobile network 12.

The mobile terminal 1 has a number of input/output ports enabling communication with external devices. In this example, these are a parallel data port 13 and an infrared (IR) port 14. Other ports may alternatively or additionally be provided, for instance a Bluetooth™ port.

The wireless network 12 includes a server 15, referred to as an activity setting server, that holds activity settings for a plurality of mobile terminals 1 and makes these settings available to other terminals 1 and devices, including other servers 15 in other networks.

The mobile terminal 1 may further include or be connectable to one or more user activity detectors or sensors including, but not limited to, a movement sensor 16, a location sensor 17 and a heartbeat monitor 18, which will be described in detail hereinafter.

A global user activity setting for the mobile device is made available to application programmers via the device application program interface (API). Applications can therefore be configured to monitor the global setting and to retrieve it when it changes using any coding language supported by the device.

An instant messaging (IM) application is an example of one of a number of applications which are stored in the memory 3 and can be run individually or concurrently by the CPU 2. When running on the mobile terminal 1, the IM application enables a user operating the mobile terminal 1 to send ‘instant’ messages to other user terminals that have the IM application. The IM application also stores a user activity setting that is made available to other mobile terminals via the mobile network 12. The IM user activity setting indicates the current activity of the user and can, for example, be set to any of a predetermined group of settings. For instance, the user activity setting can be ‘Text Messaging’, ‘Driving’, ‘In the Cinema’, ‘In a meeting’, ‘On the Move’ and so on. The setting could alternatively be a one-time setting, for example using free text, or a setting that combines several other settings.

In response to a detected change in a user's activity, the user activity setting associated with the IM application is automatically adjusted to reflect the new activity. This is achieved by the CPU 2 automatically updating the global user activity setting stored in the memory 3 in response to the new user activity. The new global user activity setting is then retrieved by or transmitted to the IM application running on the mobile terminal 1 and used to set the IM user activity setting. The IM user activity settings are therefore adjusted automatically in response to detected changes in a user's activity that result in the global activity setting being updated.

A user can choose whether or not to have their global activity setting or other application activity settings updated automatically by adjusting update preferences stored in the memory 3. The user can, for instance, choose never to have their global activity setting automatically updated, or only to have it updated automatically in response to certain activities in which they participate, or for certain applications that they use.

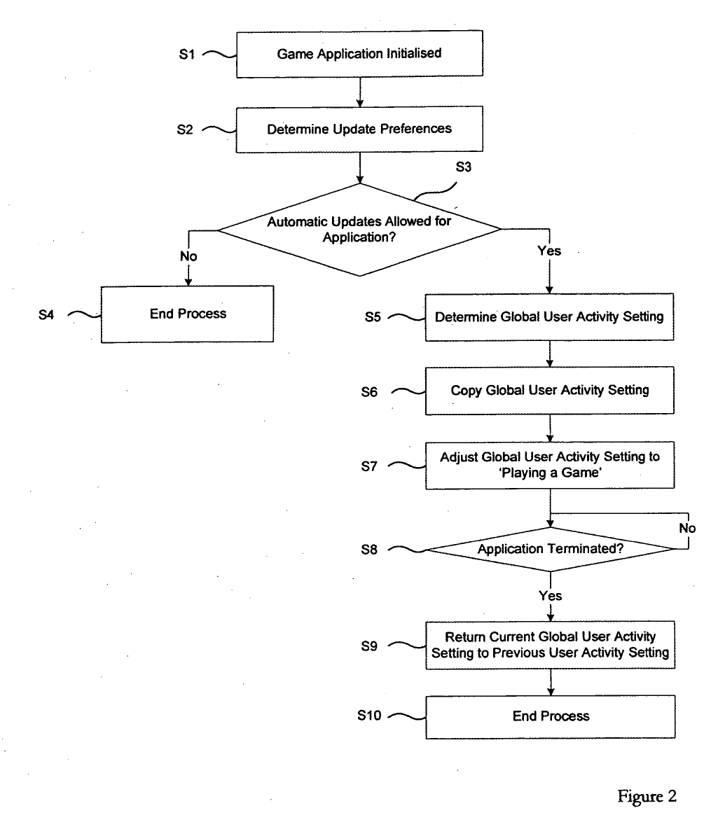

FIG. 2 illustrates steps performed by the CPU 2 in automatically adjusting the global user activity setting in response to a user playing a game stored as an application in the memory 3 of the mobile terminal 1 according to the invention.

Referring to FIG. 2, following the initialisation of the game application (step S1), the CPU 2 determines the status of the update preferences (step S2) stored in the memory 3. The update preferences are analysed (step S3) and if automatic updates are not allowed, the process is terminated (step S4). Conversely, if the update preferences indicate that automatic updates are allowed, the CPU 2 determines the value of the current global user activity setting (step S5). The current global user activity setting is copied to a separate location of the memory 3 (step S6) before being adjusted to the predetermined value ‘Playing a Game’ (step S7). The CPU determines when the game application is terminated (step S8), and once this has occurred, the global user activity setting is returned to its previous value by copying it back from the separate memory location (step S9). The process is then ended (step S10).

The IM application and other such applications are programmed to access the global user activity setting. Therefore, when the global activity setting is adjusted in response to a change in the user's activity, the IM or other application user activity settings are adjusted accordingly.

A change in user activity is not limited to the user playing a game. For instance, the new user activity may be use of other features of the mobile terminal 1, for instance accessing a text message or composing a new text message, resulting in the global activity setting ‘text messaging’. Alternatively, the user activity may be accessing internet content using a web-browsing application. In this case, a distinction can be made between a standard internet connection and a secure internet connection. Secure connections are conventionally established between a client terminal and a content server of a network such as the internet for transfer of sensitive or confidential information such as banking information. Interruption of a secure connection is generally undesirable and therefore, in the event that a secure connection is established or determined to be present, the user activity setting can be adjusted to reflect this, for instance to a value such as ‘Secure Internet Connection, Do Not Disturb’.

The user activity can be a user accessing other applications running on the mobile terminal 1. For instance, the global user activity setting can be adjusted in response to a user using camera application associated with a camera (not shown) connected to the mobile terminal 1 for taking still pictures or video clips, a television application, an emailing application, an application for accessing and editing a database, such as a phone book associated with the mobile terminal 1, or an IM application. In each case, the global activity setting is updated to an appropriate value, for instance ‘Recording Video Clips’.

The user activity setting can be transmitted by the mobile terminal 1 over the mobile network 12, for example via an activity settings server that stores the settings for a plurality of mobile devices. In this manner, the user activity setting can be made available to other users, for instance using session initiation protocol (SIP) specific event notification.

The user activity is not limited to use of the mobile terminal 1. It extends to any activity that involves or affects the terminal. For example, the user activity may be the user travelling with their mobile terminal 1. Such movement can be detected and used to adjust the user's global activity setting accordingly.

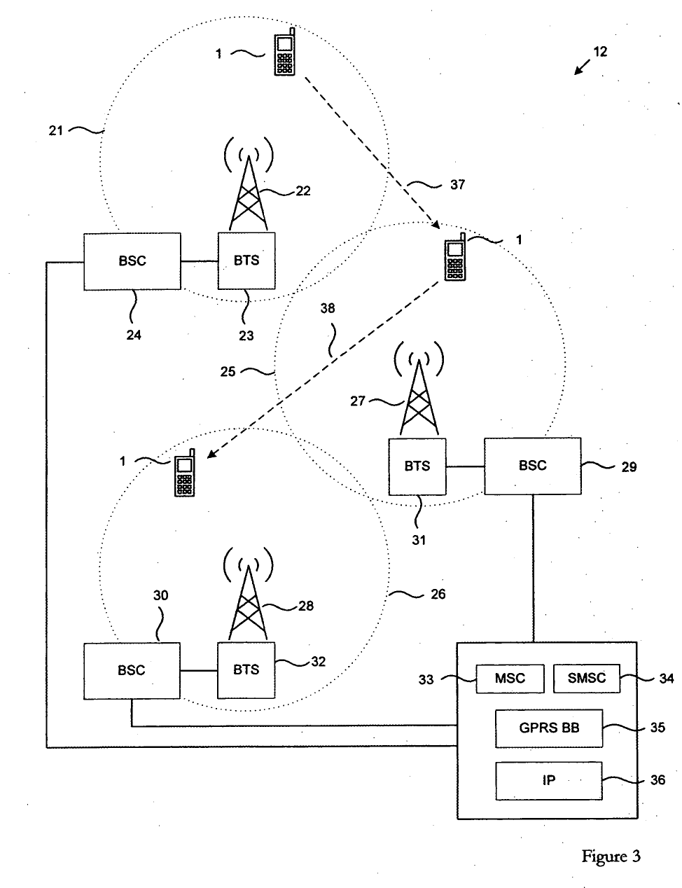

FIG. 3 illustrates the mobile network 12 in which the mobile terminal 1 operates. The mobile terminal 1 is initially located within a first cell 21 of the mobile network 12. The first cell 21 is defined by the range of a first broadcasting antenna 22 connected to a first base transceiver station (BTS) 23, which is in turn connected to a first base station controller (BSC) 24. Second and third cells 25, 26 are each defined by the range of second and third antennas 27, 28 respectively, each of these being connected to second and third BSCs 29, 30 respectively via second and third BTSs 31, 32 respectively. All of the BSCs 24, 29, 30 are connected to other mobile network components including a Mobile Switching Centre 33 (MSC), Short Message Service Centre (SMSC) 34, the General Packet Radio Service (GPRS) backbone (BB) network 35 and other networks such as an IP network 36.

In use, when the mobile terminal 1 is switched on within the first cell 21, it is registered pith the first BTS 23, and the location of the mobile terminal 1 is stored by the MSC 33. If the mobile terminal 1 is moved to a location within the second cell 25, as illustrated by dotted arrow 37, its presence is detected by the second BTS 31 and a cell hand-over of the mobile terminal 1 to the second cell 25 takes place under the control of the MSC 33. The updated location of the mobile terminal 1 is stored by the MSC 33. If the mobile terminal 1 is then moved to a location within the third cell 26, as illustrated by dotted arrow 38, its presence is detected by the third BTS 32 and a cell hand-over of the mobile terminal 1 to the third cell 26 takes place.

Since the first, second and third cells 21, 25, 26 cover different geographic areas, whilst a hand-over back and forth between two neighbouring cells may be caused by signal strength fluctuations in the signals received from the cell antennas 22, 27, 28, successive hand-overs of the mobile terminal 1 between different cells within a time period t indicate that the user of the mobile terminal 1 is travelling.

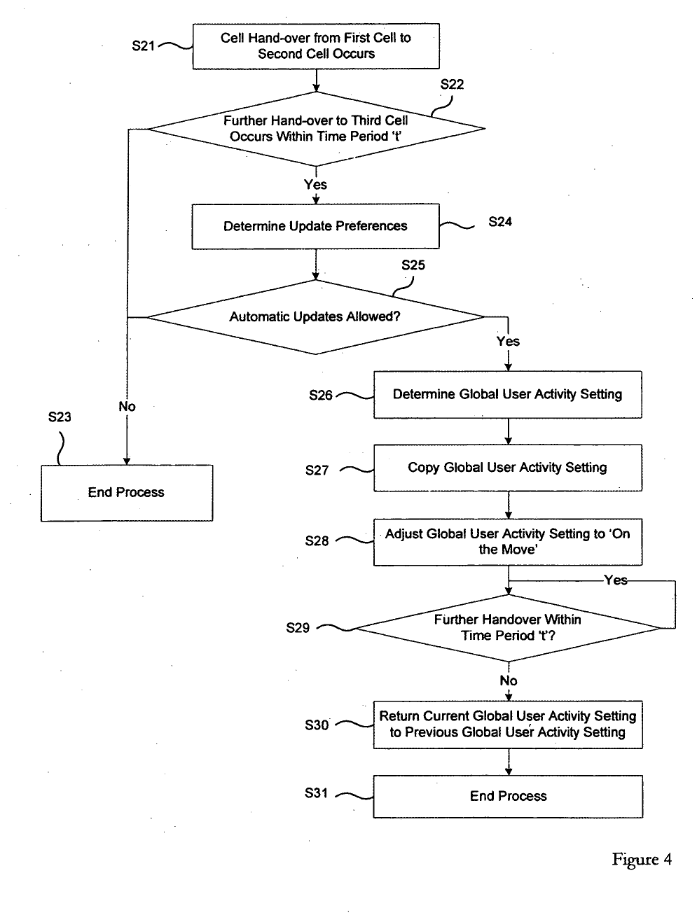

FIG. 4 illustrates processing steps performed by the CPU 2 in automatically updating the global user activity setting in response to a plurality of cell hand-overs within a predetermined time period t. The time period t is, for example, set to 5 minutes in the present example.

Following detection by the mobile terminal 1 of a cell hand-over from a first cell to a second cell (step S21), the CPU 2 is configured to determine whether a subsequent hand-over to a third cell occurs within the time period t (step S22). If no further hand-over occurs within the time period t, the process is ended (step S23). Alternatively, if a further hand-over does occur within the time period t, the CPU 2 determines what update preferences are set (step S24) and whether automatic updates of the user activity setting are allowable in this situation (step S25). In the case that automatic updates of the global user activity setting are not allowable, the process is ended (step S23). Otherwise, the current global user activity setting is determined (step S26) and copied to a separate memory location (step S27). The CPU 2 then adjusts the current global user activity setting to ‘On the Move’ (step S28) and again determines whether a subsequent cell hand-over, for instance to a fourth cell, occurs within the time period t (step S29). If so, this indicates that the user is still on the move. No change of the global user activity setting is therefore required. The CPU 2 repeatedly measures further time periods t and determines whether further cell hand-overs occur in each period t until it is determined that a cell hand-over does not occur within a time period t. In this eventuality, the global user activity setting is returned to its previous value stored in the separate memory location (step S30) and the process is ended (step S31).

Whilst the time period t is 5 minutes in the example described, other time periods can be used or alternatively a variable time period dependent on the size of the cells in question could be used. Furthermore, a number of separate time periods could be used simultaneously to indicate different forms of travel. For instance, if multiple hand-overs occur within a relatively short space of time, this could be used to indicate that the user is travelling by train. Conversely, hand-overs that are considerably less frequent could be used to indicate that the user is travelling on foot.

The invention is not limited to the CPU 2 determining movement of the mobile terminal 1 on the basis of hand-overs between cells of a mobile network 12. Alternatively, hand-overs between other network devices, also referred to as elements, associated with other networks can be detected and used to indicate movement of the mobile terminal 1. Other networks may, for instance, include a local area network (LAN), a personal area network (PAN), a wide area network (WAN), a wireless LAN, VAN or PAN. The hand-over may be a hand-over between network devices associated with the same network or with different networks or a combination of hand-overs between devices of the same and different networks.

In an alternative embodiment, a change in the strength of signals received at the mobile terminal 1 from a network element such as a BTS could be used to determine movement. In this example, changes in the signal strength are analysed for patterns indicative of movement of a mobile terminal 1. For instance, signals received from the mobile terminal 1 are analysed for a period of time, for instance 1 minute, and it is determined whether, on average, the signals have increased or decreased in strength over this time. Such a change can be used to indicate that the mobile terminal 1 has moved.

The mobile terminal 1 may, in a further embodiment, be fitted with a movement sensor 16. For instance, in one embodiment, the terminal 1 has an in-built tilt sensor whose output is connected to the CPU 2. A number of consecutive movement detections by the movement sensor 16 whilst the user is not using the mobile terminal 1 indicate that the user is travelling. For instance, if the movement sensor output indicates to the CPU 2 that the mobile terminal 1 has been moving for more than 10 seconds and that in that time the user has not used the mobile terminal 1, this triggers the CPU 2 to adjust the global user activity setting to ‘On the Move’.

The movement sensor 16 is not limited to a tilt sensor. Other movement sensors such as a gyroscopic movement sensor or a vibration sensor could alternatively be used.

Furthermore, the mobile terminal 1 can include a global positioning system (GPS) device or be connected to a GPS device to provide position and/or movement information for use in adjusting the global user activity setting. A combination of GPS information with information provided by other movement or location detecting means such as the movement sensor can be used to provide a more detailed and accurate indication of a user's activity. For example, the mode of transport being used by the user could be determined by mapping the user's speed and route to a map. Then the fact that a user is travelling by, for example, train rather than car could be used to determine their availability to hold a conversation.

In further embodiments of the invention, the global user activity setting is automatically adjusted in response to a detected change in location of a mobile terminal 1. In one such embodiment, the mobile terminal 1 entering a particular cell 21, 25, 26 of a mobile network 12 is used to indicate the user's location. For instance, when the mobile terminal 1 enters a picocell formed by an antenna and a BTS located within a localised area, for instance inside a building such as an airport or a shopping centre, the location of the user can be determined by the mobile terminal 1 based on signals it receives from the BTS. The mobile terminal may contain a list of BTSs, each associated with location or activity information. The global user activity setting can therefore be automatically updated to reflect the user's activity or location on the basis of a particular detected BTS.

Alternatively, the global user activity setting may be automatically updated in response to the mobile terminal 1 entering one or more a particular group of cells of a mobile network. These groups could be preset in the mobile terminal 1, set by a user or a third party, or automatically set by the mobile terminal 1 in use.

In another embodiment, the mobile terminal 1 includes a location detector 17, for example, a radio frequency identification (RFID) tag detector for detecting RFID tags in the proximity of the mobile terminal 1. The RFID tags to be detected are passive low frequency-tags that can be detected over several feet. Such tags can be positioned in various locations and detected by the mobile terminal 1 vixen the user is in one of those locations. For instance, an RFID tag can be positioned inside a car and detected when a user enters the car. Each RFID tag has an antenna and a microchip that stores a serial number identifying the tag. During the detection process, the RFID detector in the mobile terminal 1 receives the serial number of the detected RFID tag, which is communicated to the CPU 2. The memory 3 of the mobile terminal 1 stores a list of RFID tag serial numbers and their associated locations. This list can be preset or may be configured by a user positioning a tag and manually entering text into the mobile terminal 1 indicating the tag's location. The mobile terminal 1 is thus capable of determining a user's location and therefore their activity, based on detection of an RFID tag. The global user activity setting is therefore adjusted in response to the detection of an RFID tag.

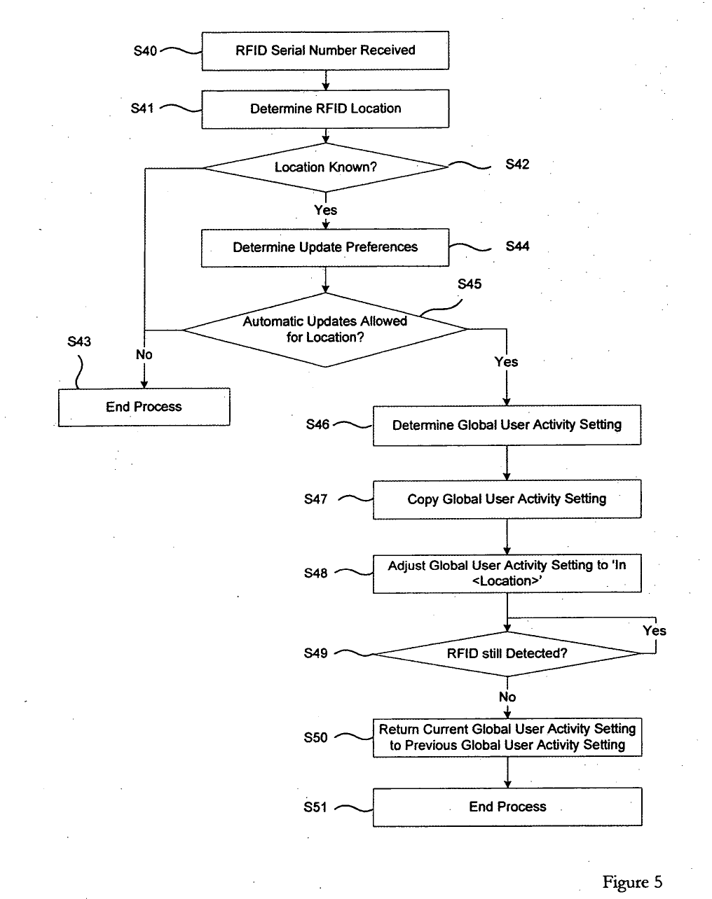

FIG. 5 illustrates the processing steps performed by the CPU 2 of a mobile terminal 1 according to the invention in automatically adjusting the global user activity setting in response to the detection of an RFID tag.

Referring to FIG. 5, upon detection of an RFID tag and receipt of its serial number (step S40), the CPU 2 accesses the memory 3 to determine the location associated with the serial number (S41). If the location is unknown, the process is ended (step S43). Otherwise, the process continues and the user update preferences are retrieved from the memory 3 (step S44). It is then determined whether automatically updating the global user activity setting in response to the user entering this location is allowable (step S45). If not, the process is ended (step S43). If automatic updates are allowed, the CPU 2 determines the current global user activity setting stored in the memory 3 (step S46) and copies it to a separate memory location (step S47). The global user activity setting is then adjusted to ‘In <Location>’, where <Location> is the location stored in the memory 3 associated with the serial number of the detected tag (step S48). The CPU 2 then continually checks that the detected tag is still detected (step S49). Once the detected tag is no longer detected, the global user activity setting is returned to its previous value stored in the separate memory location (step S50) and the process ends (step S51).

Alternatively, in response to an unknown location being found (step S42), the mobile terminal 1 may prompt the user to enter a location to be stored in the memory 3 with the serial number that has been received. This location can then be used to provide the user activity setting associated with the current and future detections of RFID tags having the serial number in question.

Other tags may be used such as high-frequency tags or active tags that operate over greater ranges. Such tags could be positioned in cinemas, airports or trains. In this case, the user's mobile terminal can have predetermined serial numbers for such tags with the associated preset user activity settings ‘In the Cinema’, ‘In the Airport’ and ‘On the Train’ respectively. Alternatively, a user may enter the user activity setting that they require in response to the detection of a particular tag.

Rather than RFID tags, the detection by the location detector 17 or by other components of the terminal 1 of other devices can be used to indicate a user's location. For instance, reception of one or more signals from a Bluetooth™ device, a personal area network (PAN) device or a wireless local area network (WLAN) device may indicate the location of the mobile terminal 1 to the CPU 2. Alternatively, a broadcast such as a radio broadcast can be detected by a radio receiver connected to or incorporated within the mobile terminal 1 and used to indicate a location. In each case, an appropriate global user activity setting can be associated with the detected device or the particular signal that is received.

The location of a user may be detected in other ways. For instance, the user entering their car may be detected by the fact that they connect an in-car accessory such as a charger or hands-free kit to their mobile terminal 1, for instance via the parallel data port 13. Alternatively, the car could have an on-board computer to which the mobile terminal 1 can be connected, for instance via a Bluetooth™ connection. Such connection may indicate that the user has entered a car and the global user activity setting of the device can be updated accordingly, for instance to ‘Driving’. The on-board computer may provide information to the mobile terminal 1 regarding the activity of the user, for example the location and/or movement of the car. This can include the driving speed, global positioning system (GPS) location as determined by a GPS device connected to the on-board computer, or information regarding the model of the car or a destination programmed into a satellite navigation device associated with the car. In this way, the global user activity setting can be updated to more accurately reflect the user's situation, for instance being set to ‘Driving Ford Mondeo™ at 20 m.p.h. through London’.

Other devices capable of detecting a user's location or movement may be connected to or incorporated within the mobile terminal 1. For instance, in one embodiment, the mobile terminal 1 has an in-built heart pulse monitor 18 whose output is connected to the CPU 2. Heart rates determined by the monitor 18 can be used to automatically adjust the global user activity setting. For instance, a low heart rate could be used to adjust the user activity setting to ‘Relaxing’ and a high heart rate could result in the activity setting ‘Exercising’. Information received from the heart monitor 18 can be combined with other information indicative of a user's location and/or movement. For instance, a high heart rate combined with information indicating that the mobile terminal 1 is moving could result in the user activity setting ‘Jogging’.

In another embodiment, an air sensor is incorporated within or connected to the mobile terminal 1 for detecting air movement or other characteristics of the environment in the proximity of the mobile terminal 1. This can provide further information regarding the movement and/or location of the mobile terminal 1 for use in updating the global user activity setting. For instance, the output of the air sensor can indicate whether the mobile terminal 1 is indoors or outdoors and, from changes in the output characteristics, whether the device is moving.

In a further embodiment, a microphone associated within the mobile terminal 1, for instance the standard mobile terminal microphone 6 or alternatively an additional microphone (not shown), is used to detect noise in the proximity of the mobile terminal 1. This can provide further information regarding the location of the mobile terminal 1 for use in updating the global user activity setting. For instance, the output of the microphone 6 can indicate whether the mobile terminal 1 is in a loud environment such as a disco or in a relatively quiet environment. Updating the user activity setting in this case can have the advantage of enabling other users to be informed of the best way to communicate with the user of the mobile terminal 1, for instance by text message when loud background noise would inhibit a telephone call.

In an alternative embodiment, establishment of an IR connection with a PC is used to indicate that a user is at the office. In this case, the global user activity setting can be adjusted to a suitable value, for instance ‘In the Office’.

Connection of the mobile terminal to a particular cellular network, local area network (LAN), wireless LAN (WLAN), personal area network (PAN), wireless PAN, wide area network or wireless WAN could be used to indicate the location of a user and therefore to adjust the global user activity setting accordingly.

The invention is not limited to adjusting user activity settings. Further settings, for instance the user profile associated with the terminal 1 can be automatically adjusted according to user activity information.

The user profile comprises, for instance, a plurality of user-editable settings associated with a mobile terminal that control various aspects of the user interface, such as the screen display and the sound and vibration alerts associated with functions of the terminal such as receiving telephone calls and text messages. The user profile may be adjusted directly in response to detected activities performed by a user or in response to changes to the global user activity setting.

In the case that a user profile of the mobile terminal 1 is adjusted in response to a change in the global user activity setting, the user can specify whether automatic updates of the user profile are allowable by adjusting user profile update preferences stored in the memory 3.

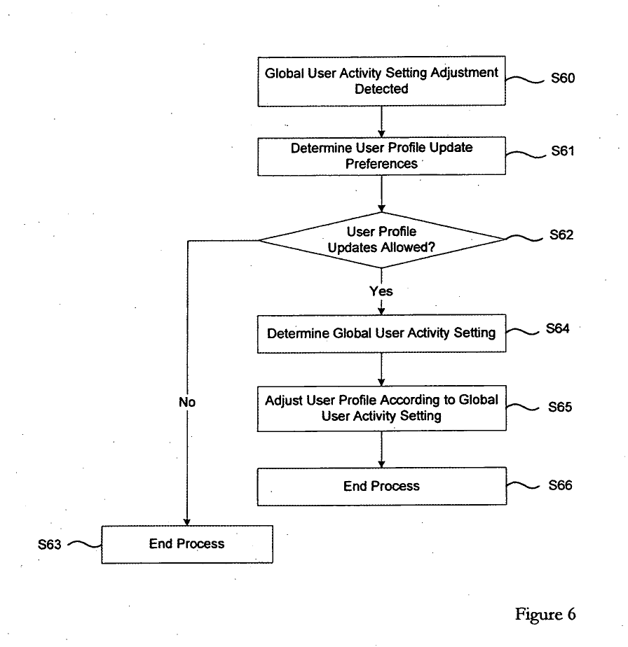

FIG. 6 illustrates the processing performed by the CPU 2 in adjusting a user profile associated with the mobile terminal 1 according to a global user activity setting adjustment.

Following detection by the CPU 2 that a global user activity setting adjustment has occurred (step S60), the CPU 2 determines the current user profile update preferences (step S61). From the update preferences, the CPU 2 determines whether automatic updates of the user profile are allowed (step S62) and, if not, the process ends (step S63). Alternatively, if automatic updates are allowed, the CPU 2 accesses the global user activity setting of the mobile terminal 1 (step S64) and adjusts the user profile of the mobile terminal 1 in accordance with the global user activity setting (step S65). In this example, the CPU 2 accesses a user-defined look-up table stored in the memory 3 containing listings of global user activity settings and their associated user profiles. Alternatively, the look-up table may be pre-set without requiring user input. In either case, the look-up table may be user editable according to their specific preferences. The process is then ended (step S66).

Therefore, the user is not required to adjust their user profile every time their situation changes.

It is not necessary that an application is running on the mobile terminal 1 for the application's settings to be adjusted. For instance, the CPU 2 may be operable to adjust application settings stored in the memory 3 when the corresponding applications are not running. It will be understood that the settings for a plurality of active and dormant applications can be set concurrently.

Alternative embodiments of the invention would be apparent to the skilled person. For instance, the user activity setting of applications such as the IM application is not limited to being updated in response to changes to the global user activity setting. Alternatively, the user activity settings of such applications can be adjusted according to the user profile of the mobile terminal 1. For instance, setting the user profile to a value such as ‘meeting mode’ results in the user activity setting of the IM application being adjusted to ‘In a Meeting’. The user may have the option of defining the relationship between user profiles and user activity settings for this purpose.

A user activity may be detected using a combination of the detection means described. For instance, both location information received from an RFID tag and movement information can be used simultaneously to indicate the user activity. In one example, the global user activity setting is adjusted to ‘Driving’ when an RFID tag located in a car is detected together With movement of the mobile terminal 1. Other combinations are possible. For instance, when the user is determined to be playing a game and the mobile terminal 1 is detected to be in a train, the global user activity setting is adjusted to ‘Playing a Game on the Train’.

The IM application whose user activity setting is automatically updated according to the invention can be any of a number of suitable applications such as AOL Instant Messenger™, ICQ™ instant messaging service, MSN Messenger™, Yahoo Instant Messenger™, Jabber™, and so on.

The invention is also not limited to use with IM applications. Other applications that utilise user activity settings, including, but not limited to, applications developed by the Wireless Village initiative, the Open Mobile Alliance or the Internet Engineering Task Force (IETF). The application may, for example, comprise an emailing application, Push-over-Cellular (PoC) application or, for instance, the phonebook of a mobile device.

The invention is not limited to use in a mobile network 12, but may also be applied in other networks such as LANs, WANs, PANs or wireless broadband networks, for instance those developed by Flarion™ or the WiMAX forum™.

The invention is not limited to adjusting the user activity setting at a mobile terminal. Alternatively, the user activity setting can be adjusted by a separate device, for instance connected within a network in which a mobile terminal is located. In one example, a network element, in this case a server 15 located within a cellular network, is equipped with a processor that receives information indicative of a user's activity and is configured to adjust a user activity setting stored in a memory device associated with the server accordingly. The user activity setting is then transmitted to the mobile terminal by a transmitter associated with the server. In addition it can be made available to other devices. For instance, the server can be configured to receive information from a BSC indicating the cell in which a particular mobile terminal is located. This information can be used by the server to automatically adjust a user activity setting associated with the mobile terminal, for instance to a predetermined value set by a user for that cell. The server may alternatively receive information from the mobile terminal itself indicating a movement and/or location detected by the mobile terminal as previously described, or indicating an application that a user of the mobile terminal is using. The user activity setting stored at the server can be adjusted accordingly.

In addition, the server can change the user activity setting in response to changes made at the network side. For example, when an incoming call is detected destined for the user, the server can immediately change the user activity setting at the network side.

The mobile terminal 1 may be a mobile telephone, but is not limited to a mobile telephone. The mobile terminal 1 can comprise any mobile device, for instance a laptop, a personal digital assistant or an in-car computer.

While a number of different devices and scenarios have been mentioned including use of an air sensor, a heart monitor and the like, the invention is not limited to the examples described and encompasses any other type of sensing device or scenario that is suitable for determining a user or device activity. Although some of the aspects have been mentioned in connection with a particular embodiment, application to other embodiments is also envisaged. For example, an increasing heart rate detected by the heart monitor can also result from the fact that the user is running, which means that the device the user carries is also moving. The heart monitor therefore provides information indicative of movement of the mobile device.

More generally, although illustrative embodiments of the present invention have been described herein with reference to the accompanying drawings, it is to be understood that the invention is not limited to these embodiments and that various changes and modifications to them may be carried out by one skilled in the art without departing from the scope and spirit of the invention.

What is claimed is:

1. A mobile device comprising:
a processor configured to automatically adjust at least one user activity setting associated with the mobile device in response to information indicative of the movement of the mobile device.

2. A mobile device according to claim 1, wherein the user activity setting is associated with an application operable to run on the mobile device.

3. A mobile device according to claim 2, wherein the application comprises an instant messaging application.

4. A mobile device according to claim 1, wherein the processor is configured to adjust a setting associated with an application operable to run on the mobile device in accordance with the user activity setting.

5. A mobile device according to claim 4, wherein the setting is at least one of a sound and a vibration setting.

6. A mobile device according to claim 1, wherein the processor is configured to adjust a plurality of respective settings, each associated with a respective one of a plurality of applications operable to run on the mobile device, said adjustment being carried out in accordance with the user activity setting.

7. A mobile device according to claim 1, comprising a transceiver configured to transmit the user activity setting over a network.

8. A mobile device according to claim 1, wherein the processor is configured to automatically adjust the user activity setting in response to detection of at least one hand-over of the mobile device between elements of at least one network.

9. A mobile device according to claim 8, wherein the processor is configured to automatically adjust the user activity setting according to the frequency of detected hand-overs.

10. A mobile device according to claim 9, wherein the detected hand-overs comprise a first hand-over between a first network element and a second network element and a second hand-over between the second network element and a third network element.

11. A mobile device according to claim 8, wherein the network comprises at least one selected from the group comprising a cellular network, a local area network (LAN), a personal area network (PAN), a wide area network (WAN), a wireless LAN, a wireless PAN and a wireless WAN.

12. A mobile device according to claim 1, wherein the processor is configured to automatically adjust the user activity setting in response to a change in the signal strength of signals received at the mobile device.

13. A mobile device according to claim 1, comprising a movement sensor configured to detect movement of the mobile device.

14. A mobile device according to claim 1, comprising a memory configured to store a preference relating to the allowability of automatic user activity setting adjustments.

15. A mobile device according to claim 1, comprising an air sensor for detecting environmental characteristics in the vicinity of the device.

16. A mobile device according to claim 1, Herein the processor is configured to adjust a user profile of the mobile device according to the user activity setting.

17. A mobile device comprising:
a processor configured to automatically adjust at least one user activity setting associated with the mobile device in response to information indicative of the location of the mobile device.

18. A mobile device according to claim 17, wherein the user activity setting is associated with an application operable to run on the mobile device.

19. A mobile device according to claim 17, wherein the processor is configured to adjust a setting associated with an application operable to run on the mobile device in accordance with the user activity setting.

20. A mobile device according to claim 19, wherein the setting is at least one selected from the group comprising a sound setting and a vibration setting.

21. A mobile device according to claim 17, wherein the processor is configured to adjust a plurality of respective settings, each associated with a respective one of a plurality of applications operable to run on the mobile device, said adjustment being carried out in accordance with the user activity setting.

22. A mobile device according to claim 17, comprising a detector configured to detect that the mobile device is located within a vehicle.

23. A mobile device according to claim 17, comprising a detector configured to detect an in-car accessory connected to the mobile device.

24. A mobile device according to claim 17, comprising a detector configured to detect a radio frequency tag and to provide a signal to the processor indicative of the detected radio frequency tag.

25. A mobile device according to claim 17, wherein the processor is configured to automatically adjust the user activity setting in response to communications received at the mobile device from an element of at least one network.

26. A mobile device according to claim 25, wherein the network comprises at least one selected from the group comprising a cellular network, a local area network (LAN), a personal area network (PAN), a wide area network (WAN), a wireless LAN, a wireless PAN and a wireless WAN.

27. A mobile device according to claim 25, wherein the network comprises a cellular network and the network element comprises a base transceiver station.

28. A mobile device according to claim 17, comprising a memory configured to store a preference relating to the allowability of automatic user activity setting adjustments.

29. A mobile device according to claim 17, Herein the processor is configured to adjust a user profile of the mobile device according to the user activity setting.

30. A network element configured to automatically adjust a user activity setting associated with a mobile device in response to information indicative of the movement of the mobile device.

31. A network element according to claim 30, configured to automatically adjust the user activity setting in response to a signal received from the mobile device.

32. A network element according to claim 30, configured to automatically adjust the user activity setting in response to detection of at least one hand-over of the mobile device between components of at least one network.

33. A network element according to claim 30, configured to automatically adjust the user activity setting according to the frequency of detected hand-overs.

34. A network element according to claim 32, wherein the at least one network comprises at least one selected from the group comprising a cellular network, a local area network (LAN), a personal area network (PAN), a wide area network (WAN), a wireless LAN, a wireless PAN and a wireless WAN.

35. A network element according to claim 30, comprising a server arranged to receive the information indicative of the movement of the mobile device from the mobile device, and in response to the information to change the user activity setting held at the server for the mobile device, the server being arranged to make the user activity setting available to a plurality of other devices.

36. A network element according to claim 30, wherein the movement of the mobile device is sensed by apparatus external to the mobile device, the network element comprising a server arranged to receive information indicative of the movement of the mobile device from said apparatus, and in response to the information to change the user activity setting held at the server for the mobile device.

37. A network element according to claim 36, wherein the server is arranged to send the user activity setting to the mobile device.

38. A network element according to claim 36, wherein the server is arranged to make the user activity setting available to a plurality of other devices.

39. A network element configured to automatically adjust a user activity setting associated with a mobile device in response to information indicative of the location of the mobile device.

40. A network element according to claim 39, wherein the network element is associated with a network comprising at least one selected from the group comprising a cellular network, a local area network (LAN), a personal area network (PAN), a wide area network (WAN), a wireless LAN, a wireless PAN and a wireless WAN.

41. A network element according to claim 39, configured to automatically adjust the user activity setting in response to a signal received from the mobile device.

42. A network element according to claim 39, comprising a server arranged to receive the information indicative of the location of the mobile device from the mobile device, and in response to the information to change the user activity setting held at the server for the mobile device, the server being arranged to make the user activity setting available to a plurality of other devices.

43. A network element according to claim 39, wherein the location of the mobile device is sensed by apparatus external to the mobile device, the network element comprising a server arranged to receive information indicative of the location of the mobile device from said apparatus, and in response to the information to change the user activity setting held at the server for the mobile device.

44. A network element according to claim 43, wherein the server is arranged to send the user activity setting to the mobile device.

45. A network element according to claim 43, wherein the server is arranged to make the user activity setting available to a plurality of other devices.

46. A mobile device comprising:
a processor configured to automatically adjust a user activity setting associated with the mobile device in response to an activity performed by a user of the mobile device that is other than communicating using the mobile device.

47. A mobile device according to claim 46, wherein the activity comprises use, by a user, of an application running on the mobile device.

48. A mobile device according to claim 47, wherein the application comprises at least one selected from the group comprising a game, a web browser, a television application, a radio application and a streaming application.

49. A mobile device according to claim 46, wherein the processor is configured to automatically adjust the user activity setting in response to a secure internet connection associated with the mobile device.

50. A mobile device according to claim 46, wherein the processor is configured to automatically adjust the user activity setting in response to the output of a heart monitor associated with the mobile device.

51. A mobile device according to claim 46, wherein the processor is configured to automatically adjust a user activity setting in response to the output of a microphone associated with the mobile device.

52. A mobile device according to claim 46, wherein the processor is configured to adjust a user profile of the mobile device according to the user activity setting.

53. A method of automatically adjusting a user activity setting associated with a mobile device, the method comprising:
adjusting the user activity setting in response to information indicative of the movement of the mobile device.

54. A method according to claim 53, comprising receiving the information at a server, adjusting the user activity setting at the server and transmitting the user activity setting from the server to the mobile device.

55. A method of automatically adjusting a user activity setting associated with a mobile device, the method comprising:
adjusting the user activity setting in response to information indicative of the location of the mobile device.

56. A method according to claim 55, comprising receiving the information at a server, adjusting the user activity setting at the server and transmitting the user activity setting from the server to the mobile device.
